(19) United States
(12) Patent Application Publication
(10) Pub. No.: US 2008/0288384 A1
(43) Pub. Date: Nov. 20, 2008

(54) System for automatic financial transaction notifications over wireless network or other network

(76) Inventors: Stephen John Collins, Morristown, NJ (US); Gaetano Liberti, Denville, NJ (US)

Correspondence Address: MCCORMICK, PAULDING & HUBER LLP, 185 ASYLUM STREET, CITY PLACE II, HARTFORD, CT, 06103, US

(21) Appl. No.: 11/804,363

(22) Filed: May 17, 2007

(51) Int. Cl. G06Q 40/00

(52) U.S. Cl. 705/35

(57) ABSTRACT

In a method and system for automatically notifying a user when financial transactions (e.g., debit card transactions and credit card transactions) are carried out in association with the user's credit card or other financial account, each time a financial transaction is completed, a notification message is generated and transmitted to a user-designated terminal. Examples include transmitting e-mails, other text messages, or audio messages to the user's home computer terminal or mobile phone or other wireless unit. The notification message contains information identifying the user account and specifying the nature of the transaction, such as monetary amount, time of day and date, and where the transaction occurred. The notification is generated and transmitted substantially immediately after the transaction is completed. This way, a user is informed of each transaction separately and substantially contemporaneously with when the transaction is carried out, allowing users to intuitively assess the transaction from a time sense.

### FIELD OF THE INVENTION

The present invention relates to financial transaction systems and, more particularly, to systems for providing information to users about financial transactions.

### BACKGROUND OF THE INVENTION

Credit card fraud involves unauthorized third parties using fraudulently or illegally obtained credit card account information to pay for goods or services, or to otherwise obtain an ill gotten financial benefit. With the advent of the Internet, credit card fraud has become even more prevalent, since criminals can take advantage of computer-based fraud methods, lapses in online security, and the improved capability of the Internet to easily and anonymously exchange information, e.g., to buy and sell stolen credit card information.

On an account-by-account basis, once an account holder or financial institution becomes aware of fraudulent activity, it is relatively easy to stop. Typically, the account is put on hold, illegal transactions are contested, and a new account number is issued to the account holder. However, in many instances there is a delay between when the fraudulent activity commences and when it is detected. For example, although financial institutions have algorithms for identifying suspicious activity, by necessity these focus primarily on the statistical outliers to the typical range of transactions, e.g., very large transactions, numerous transactions in a very short time period, or transactions that take place in distant geographical locations. Account holders, on the other hand, are in the best position for determining if transactions on their accounts are valid. However, financial institutions only issue statements on a monthly basis, and there is no guarantee that the user will closely review the statement. Users may obtain more up-to-date information from a financial institution website, but many users don't take advantage of such services, or perhaps only seldom or occasionally. Such delays can result in a greater degree of illegal activity and financial loss than would otherwise occur if the activity was detected more quickly.

### SUMMARY OF THE INVENTION

An embodiment of the present invention relates to a method and system for automatically notifying a user when financial transactions, e.g., debit card transactions and credit card transactions, are carried out in association with the user's credit card or other financial account. Each time a financial transaction is carried out, a notification message is generated and transmitted to an external terminal designated by the user, e.g., a computer terminal or wireless unit. By “external” terminal, it is meant an end-user terminal that is not part of the financial transaction network for authorizing and processing financial transactions. The notification message contains information relating to the financial transaction, such as an identifier of the user account, a monetary value or amount of the transaction, and a time, date, and location of the transaction.

In another embodiment, the message is generated and transmitted substantially immediately after the transaction is carried out. (“Substantially” immediately means immediately but for any delays inherent to the system due to electronic processing and communication times or the like.) This way, a user is informed of each transaction separately, as well as substantially contemporaneously with when the transaction is carried out. Intuitively, users can assess the transaction from a time sense, e.g., “Yes, although I received a notification message, I recently used my credit card” or “Uh oh, I received a notification message, but haven't used my credit card recently,” and take action if warranted based on the further contents of the notification message.

Notification messages may take many different forms, such as e-mails, short message service messages (e.g., instant text message), or computer-generated voice messages using voice synthesis.

In another embodiment, a table, list, or other data structure is associated with each user's account. The data structure indicates whether the account is signed up for the notification service, and includes one or more user- and/or system-designated options/criteria for the service. Examples include user terminal communication identifier (such as e-mail address or phone number), notification type (e.g., text message or voice message), and the like. When a financial transaction is processed for the user's account, the table is accessed for determining whether notifications are to be sent, and in what manner.

In another embodiment, the notification message includes an option for the user to place the account and/or transaction in a contested state. In the case of an account, this means that all new account activity is disallowed until various measures are undertaken, such as the user contacting the financial institution, or the financial institution issuing a new account number. In the case of a particular transaction, this means that the validity of the transaction is questioned, e.g., the transaction is specified as not being authorized by the account holder, for initiating further action at the financial institution level. The “contest” option may be, for example, a link in an e-mail or other text message, a designated phone keypad selection in response to a voice message prompt, or the like.

In another embodiment, financial transactions are screened, according to one or more criteria, before a notification message is transmitted. Criteria may be set by the user or by the financial institution, and could include considerations of type, monetary size, location, time and date, and the like. Thus, very small transactions may be omitted from the notification process, or transactions that occur at a particular place or time, or transactions that are generated internally by the financial institution. For example, if a credit card is used frequently at a particular location, it is unlikely that fraudulent activity will occur at that same location. The user may elect not to receive notifications of account activity taking place at that location, to avoid being inundated with frequent notifications that are unlikely to indicate fraudulent activity.

### BRIEF DESCRIPTION OF THE DRAWINGS

The present invention will be better understood from reading the following description of non-limiting embodiments, with reference to the attached drawings, wherein below:

FIG. 1 is a schematic diagram of a financial transaction notification system according to an embodiment of the present invention;

FIGS. 2 and 4 are flow charts showing operation of various portions of the system; and

FIG. 3 is a schematic diagram of an audio message generation system.

### DETAILED DESCRIPTION

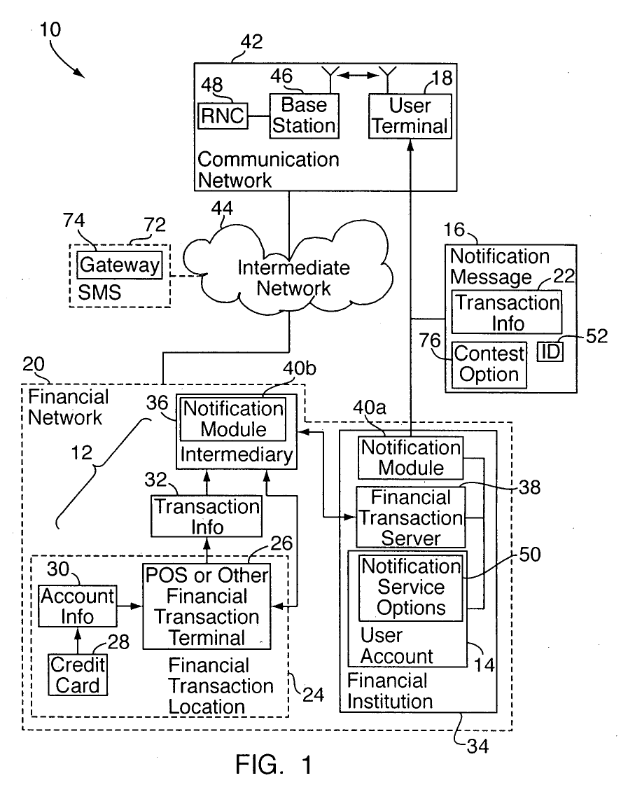

With reference to FIG. 1, a system 10 is provided for automatically notifying a user when financial transactions 12, e.g., debit card transactions and credit card transactions, are carried out in association with the user's credit card or other financial account 14. Each time a financial transaction 12 is carried out, a notification message 16 is generated and transmitted to an external terminal 18 designated by the user. By “external” terminal, it is meant an end-user terminal (e.g., a computer terminal or wireless unit) that is not part of the financial transaction network 20 for authorizing and processing financial transactions 12. The notification message 16 contains information 22 relating to the financial transaction, such as an identifier of the user account, a monetary value or amount of the transaction, and a time, date, and location of the transaction.

The system 10 is applicable for implementation as part of any financial network 20. In particular, although the system 10 is illustrated herein the context of a credit card or debit card transaction, it is applicable to any type of financial transaction where charges are applied to a user account. FIG. 1 illustrates a typical credit card or debit card transaction 12. At a location 24 where financial transactions are carried out, such as a store, gas station, or restaurant, a user interacts with a POS (point of sale) or other financial transaction terminal 26. The POS terminal 26 may be, for example, part of a self-serve gas pump, cash register, or other payment station that includes electronic data capture functionality. A credit card 28 is used to provide account information 30 to the POS terminal 26, such as a credit card account number, country code, account holder name, issuing bank/financial institution, and expiration date. The account information 30 is encoded in a magnetic stripe on the back of the card. The credit card is swiped through a magnetic stripe reader built into the POS terminal, which reads the account information 30 from the magnetic stripe. The POS terminal 26 then transmits information 32 about the transaction either directly to a financial institution 34, or, more typically, to one or more intermediary server terminals 36. The transaction information 32 includes all or a portion of the account information 30, as well as the monetary amount of the purchase/transaction.

The financial institution 34 may be, for example, a bank, company, or other institution that issued the credit card 28, and that manages the user's account 14 including issuing statements and collecting payments. The intermediary servers 36 may include, for example, server terminals associated with a merchant bank or other financial institution that has a business relationship with the merchant/location 24 and that receives all credit card transactions from that location 24, and/or server terminals associated with a bankcard association such as MasterCard® or Visa®. The POS terminal 26 contacts (by telephone line or other data line) a designated intermediary server 36, which routes the POS terminal's communication 32 to the financial institution 34. Based on the received information 32, a server terminal 38 controlled by the financial institution 34 verifies that the account 14 exists, that the card 28 being used has not been reported as stolen, and that the transaction would not put the user over his or her credit limit. Assuming that everything is in order, an authorization code is transmitted back to the intermediary server(s) 36 and to the POS terminal 26. Once the authorization code is transmitted, the financial institution server 38 puts a hold on the user's account for the amount of the transaction. Note that account has not been actually charged yet.

Once the authorization code is received at the POS terminal 26, it prints out a sales draft or slip for the user to sign. At a later time, the authorizations stored in the POS terminal are reviewed against the signed sales drafts. When all the credit card authorizations have been verified to match the actual sales drafts, data relating to the authorized credit card transactions is transmitted to merchant bank 36 for deposit. For the particular transaction 12, the merchant bank performs an “interchange” for the sales draft with the appropriate card-issuing financial institution 34. The financial institution 34 transfers the amount of the sales draft, minus an interchange fee, to the merchant bank, which deposits it into the merchant's account, less a discount fee. The financial institution 34 then finalizes the hold placed against the user's account 14, which becomes a charge that the user must re-pay according to the terms of the credit card 28.

The system 10 may be configured in different ways for how, when, and where the notification messages 16 are generated. For example, a notification module 40a could be put in place as part of the financial institution system 34, or a notification module 40b could be put in place as part of an intermediary system 36, e.g., Visa® or other bankcard association server. (By “module,” it is meant an electronics hardware and/or software sub-system, configured to implement the functionality of the system 10.) In the case of the former, notification messages 16 could be generated substantially immediately after each time a financial transaction 12 is authorized and a corresponding hold is placed on the user's account 14. Alternatively or additionally, notification messages 16 could be generated when finalized charges are applied to the user's account 14. In the case of a notification module 40b in place on an intermediary server/system 36, notification messages could be generated when the server 36 receives an authorization request from a POS terminal 26, and/or when the server 36 receives a granted authorization code from a financial institution 34. Other variations are possible.

If notifications are based on when a hold is placed on a user account, or upon similar stimulus generally contemporaneous with the occurrence of the financial transactions, the notification messages 16 will be generated and transmitted substantially immediately after the transaction occurs. (“Substantially” immediately means immediately but for any delays inherent to the system due to electronic processing and communication times or the like.) This way, a user is informed of each transaction separately, as well as substantially contemporaneously with when the transaction is carried out. This enables users to intuitively assess the transaction from a time sense. For example, if the user pays for a transaction with a credit card 28 and receives a notification message shortly thereafter, the user will realize that the transaction was legitimate, without even having to carefully assess the contents of the message. On the other hand, if the user receives a notification message but did not recently use the credit card, the user will know that the transaction was likely fraudulent.

As shown in FIG. 1, the financial network 20 is connected to one or more communication networks 42, in a standard manner as part of the global communication infrastructure 44, e.g., through various gateways, firewalls, intermediate networks, and the like. The communication network 42 is a general-purpose communication network (e.g., the Internet, or other computer network, a wireless communication network for wireless/mobile communications, other telephone network, or the like) for communications between end-user terminals 18. The financial network 20 encompasses all the computer and other electronic terminals, software systems, and communication pathways that are configured and used to automatically electronically process credit card, debit card, and other financial transactions for application against user accounts, including charge authorizations and the electronic transfer of funds between accounts. More generally, the financial network is a logical entity (e.g., elements logically grouped together for a particular purpose), and as such may overlap the communication network 42. In other words, the elements of the financial network may communicate over and/or form part of the communication network 42, but are considered to form a logically separate financial network. Thus, although there may be overlap of the networks 20, 42, and although there may also be communications between end-user terminals and the financial network, e.g., for users to access account information, because the end-user terminals are not part of the financial network infrastructure for automatically electronically processing credit card, debit card, and other financial transactions for application against user accounts, they are considered external to the financial network and not part of the financial network.

Typically, the system 10 will be configured to generate notifications 16 for transmission across one or more standard, publicly accessible communication networks 42, such as the Internet, commercial wireless networks, and public switched telephone networks. For example, if the network 42 is a wireless network, then it may include one or more fixed base stations 46, each with various transceivers and antennae for radio communications with a number of distributed wireless unit terminals 18, e.g., mobile phones, wireless PDA's, computerized vehicle navigation systems, wireless devices with high-speed data transfer capabilities, such as those compliant with “3-G” or “4-G” standards, “WiFi”-equipped computer terminals, or the like. The base stations 46 are in turn connected to a mobile switching center, radio network controller. (“RAN”), or other component(s) 48 which functions as the interface between the base stations 46 and the rest of the network, including directing data transfer to and from the base stations 46 for transmission to the wireless units 18.

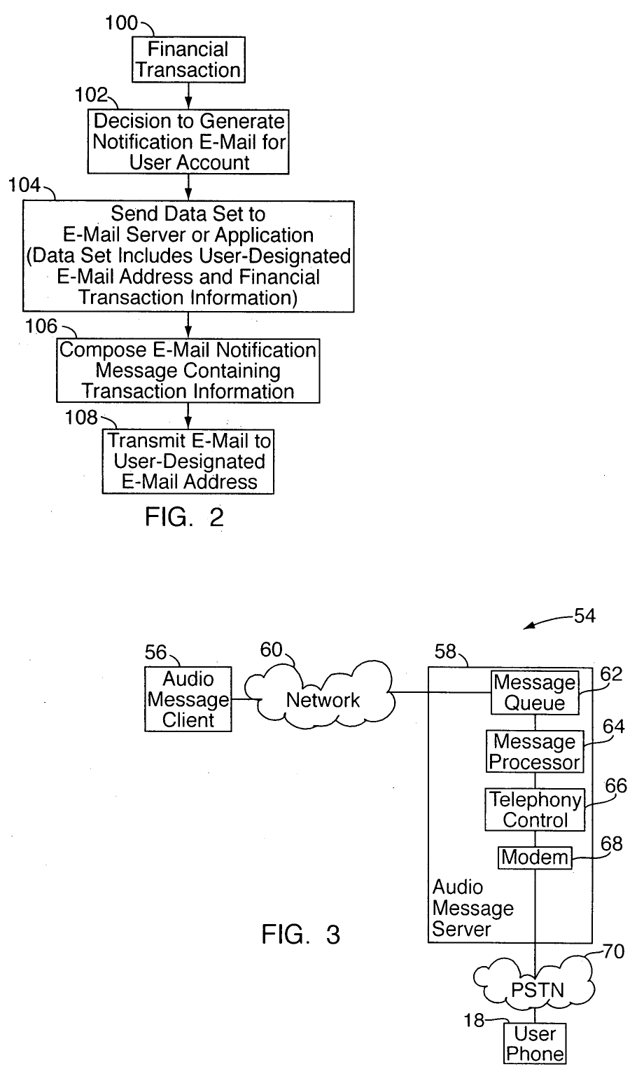

For transmitting notifications 26, the system 10 is interfaced with the network(s) 42 in a standard manner, depending on the characteristics of the network 42. For example, in the case of sending notifications 42 to an e-mail address, the notification module 40a would include an e-mail generation program coupled to an e-mail server or application having a direct or indirect connection to the Internet or another IP-based network. An example of the notification generation process, in the context of an e-mail notification, is summarized in FIG. 2. As indicated, at Step 102 the notification module 40a in place at a financial institution 34 initiates generation of an e-mail notification 16. As discussed above, notifications may be initiated each time a financial transaction is carried out in association with a user's account 14, as at Step 100, as triggered by information being provided to the system indicating that a transaction has been or is being carried out. For example, in the case of a credit card transaction, notifications could be generated each time a hold is placed on a user account. The decision to send an e-mail may be a standard feature of the system (e.g., the only available option), or it may be based on the user having selected to receive e-mail notifications, as set forth in a listing (or other data structure) of notification service options 50 associated with the user's account 14. At Step 104, the notification module 40a sends a set of data to the e-mail server/application. The data set includes the transaction information 22 (such as account number, transaction amount, and date/time/location information), and a communication identifier (“ID”) 52 designated by the user for sending notifications. In the case of an e-mail, the communication identifier is an e-mail address. At Step 106, the e-mail server/application then automatically composes a standard e-mail message according to a pre-designated template. The e-mail message is addressed to the designated e-mail address 52, and includes an e-mail “subject” line and body/text appropriate for a notification message. For example, the subject line could read “Recent transaction notification,” with the text informing the user that a transaction has recently occurred and providing the transaction information 22. At Step 108, the e-mail server/application transmits the e-mail notification 16 in a standard manner over its network connection.

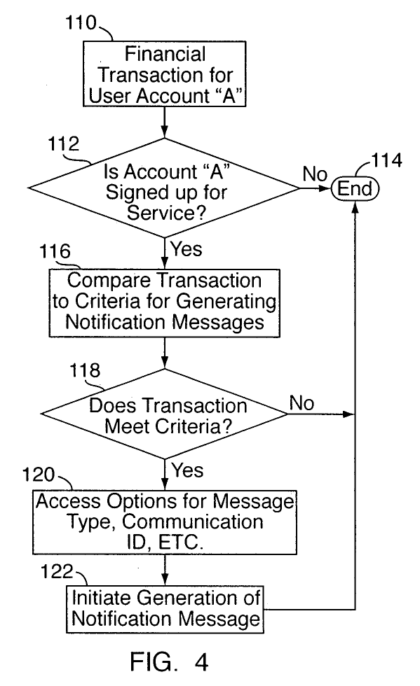

For generating audio notifications 16 for transmission to phone terminals, the notification module 40a may include or operate in conjunction with a standard audio message generation system 54, an example of which is shown in FIG. 3. Here, the notification module 40a is provided with an audio message client application 56. The audio message client application 56 communicates with an audio message server 58 over a network 60, which may comprise the financial network 20 or another network 44 (e.g., the Internet or other IP-based data network). The client application 56 acts as a high-level software interface for initiating the message generation procedure, without unduly tying up processing resources used by the financial institution for processing financial transactions. The server 58 is configured to carry out the actual (and more time consuming) process of converting the data to an audio message and transmitting the audio message over a phone line. To generate an audio message notification 16 for transmission to a phone 18, Steps 100-104 are carried out as in FIG. 2, but at Step 104 the data set is instead sent to the audio message client 56 according to a standard input format of the client 56. The client 56 then communicates with the server 58 over the network 60 for establishing a new client session. The client creates a message description in a plain text or other format (e.g., including the transaction information 22) and transmits the message to the server along with the telephone number 52 of the message recipient.

The client-generated message is received at a message queue 62 portion of the audio message server 58. The message queue 62 is a temporary storage or memory unit where the server stores submitted messages until they are processed. Once system resources are available, a message processor 64 processes the message for conversion from text to an internal, ready-to-send format containing audio data only. The audio data may include “stock” audio (e.g., previously stored in a WAV or other audio file) as a message introduction, in addition to custom-generated sound/audio based on the transaction information 22. For example:

<stock> “This is Bank of Switzerland calling. In regards to your credit
card account ending in” </stock>
<custom (text-to-audio)> specify last four digits of account
number </custom>
<stock>”, a transaction was carried out in the amount of” </stock>
<custom> specify transaction amount </custom>
<stock> “on” </stock>
<custom> specify date and time. </custom>
<stock> “If this transaction was not authorized, please contact customer
service at xxx-xxx-xxxx. Thank you.”

(In the above, “< . . . >” and “</ . . . >” refer to generic stop/start points only, not to html programming.)

Once an audio file/stream is generated containing the transaction information 22, it is passed from the message processor to a telephony control unit 66. The telephony control unit 66 is responsible for communicating with internal or external modems 68 attached to the server 58, which are configured for playing the audio file/stream over a telephone line connected to a public switched telephone network (“PSTN”) 70 or the like. A voice recognition engine or the like may be used for in-call progress detection, for recognizing line connection/disconnection events, and for human voice and answering machine detection. Thus, in summary, the server 58 initiates a phone call over the PSTN 70 to a user-designated phone number 52, and, assuming there is an answer, transmits an audio notification message 16 over the phone line, which includes the transaction information 22. As should be appreciated, this process is applicable to both traditional, landline phones and to wireless voice units.

In a similar manner, the system 10 may be interfaced with a network short message, service (“SMS”) 72, for generating “text message” notifications 16 or the like. The short message service is a telecommunications protocol that allows the sending of “short” (e.g., 160 characters or less) text messages. It is available on most digital wireless units. The SMS 72 facilitates the transfer of text messages between wireless units. The SMS 72 also includes an SMS gateway 74, which allows for the sending and receiving of text messages to or from devices other than wireless units. In such a case, the notification module 40a would include a standard software application for interfacing with the SMS gateway 74, to send individual or bulk text messages 16.

For other notification types, the system 10 would include standard functionality for generating and transmitting the designated notification, or for interfacing with a service for generating and transmitting the designated notification.

As noted above, a table, list, or other data structure 50 is associated with the user's account 14, which contains one or more notification service options. The options may be set by the system or designated by the user, and may include: (i) whether the account is signed up for the notification service; (ii) the type of notification to send (including the possibility that more than one type may be sent, or that different message types may be sent sequentially if previous messages fail to reach the designated recipient device 18); (iii) the communication identifier 52 of the user terminal 18 to which notifications are to be sent; (iv) the type of information to 22 to send; and (v) as discussed below, one or more additional criteria for deciding when and whether to send a notification message for any particular financial transaction. When a financial transaction is processed for the user's account, the options table/list 50 is accessed for determining whether notifications are to be sent, and in what manner.

The system 10 may be configured for the inclusion of a “contest option” 76 in the notification messages 16. The contest option 76 is a function that enables the user to place the account and/or transaction in a contested state. In the case of an account 14, this means that all new account activity is disallowed until various measures are undertaken, such as the user contacting the financial institution, or the financial institution issuing a new account number. In the case of a particular transaction 12, this means that the validity of the transaction is questioned, e.g., the transaction is specified as not being authorized by the account holder, for initiating further action at the financial institution level. The contest option 76 may be, for example, an embedded link in an e-mail or other text message, a designated phone keypad selection in response to a voice message prompt, or the like. In each case, the contest option will typically have the following characteristics: (i) the user is informed of the option to contest the transaction and/or place the account on hold; (ii) the user is provided with a simple mechanism for selecting the option, e.g., a one- or two-step process involving no more than selecting the option and possibly confirming the selection; (iii) based on user selection of the option, the account or transaction is automatically placed in a contested state, without human intervention at the financial institution; and (iv) the account and/or transaction are flagged for follow-up or other processing at the financial institution level. Reactivation of the account and/or resolution of the contested transaction will typically require involve numerous additional steps, for security purposes and the like.

Notifications 16 may be generated each and every time a financial transaction is carried out in association with a user's account. Alternatively, in another embodiment, financial transactions 12 are screened according to one or more criteria 50 before notification messages 16 are transmitted. Criteria may be set by the user or by the financial institution, and could include considerations of type, monetary size, location, time and date, and the like. Thus, very small transactions may be omitted from the notification process, or transactions that occur at a particular place or time, or transactions that are generated internally by the financial institution. For example, if a credit card is used frequently at a particular location, it is unlikely that fraudulent activity will occur at that same location. The user may elect not to receive notifications of account activity taking place at that location, to avoid being inundated with frequent notifications that are unlikely to actually indicate fraudulent activity.

This process is summarized in FIG. 4. At Step 110, a financial transaction is carried out for a user account “A,” e.g., a charge is finalized against the account, a hold is placed against the account, a debit transaction is initiated against the account, or the like. At Step 112, the system accesses the options list 50 to determine if the account is signed up for the service, or if it is otherwise eligible for the service. If not, the process ends at Step 114. If so, at Step 116 data associated with the transaction is compared to the criteria in the options list, to determine at Step 118 whether a notification should be generated for the transaction. If not, the process ends at Step 114. If so, the options list 50 is accessed at Step 120 for determining desired message type, designated communication identifier, etc. At Step 122, the system initiates generation and transmission of the notification message, in a manner as described above.

Any of the aforementioned functions/features may be provided with security features. For example, messages may be encrypted and/or limited in terms of what content is included (e.g., only displaying part of the account number, or identifying the account in terms of a user-designated “nickname”). Also, password protection may be implemented for accessing the messages and/or activating the contest option 76.

In another embodiment, notification messages are limited in scope, and only include: information identifying the account; information indicating that a transaction recently occurred; and contact information for the user to obtain more information, e.g., from a customer service representative.

Since certain changes may be made in the above-described system for automated financial transaction notifications over a wireless network or other network, without departing from the spirit and scope of the invention herein involved, it is intended that all of the subject matter of the above description or shown in the accompanying drawings shall be interpreted merely as examples illustrating the invenitive concept herein and shall not be construed as limiting the invention.

We claim:

1. A method of notifying users about financial transactions, said method comprising:
each time a financial transaction is carried out in association with an account of a user, generating a notification relating to the transaction; and
initiating transmission of the notification to a terminal associated with the user, wherein the terminal is external to a financial network where the transaction is carried out.

2. The method of claim 1 wherein the notification is generated substantially immediately after the transaction is carried out.

3. The method of claim 1 wherein:
the financial transaction is a credit card transaction or a debit card transaction; and
the notification contains information relating to the financial transaction, said information including at least one of an identifier associated with the user account, a monetary value of the transaction, and a time, date, and location of the transaction.

4. The method of claim 1 wherein the notification is transmitted based on a user designation of the user terminal.

5. The method of claim 1 wherein the notification is one of an e-mail, a text message generated by a communication network short message service, and an electronically-generated voice message.

6. The method of claim 5 further comprising:
selecting the type of notification to transmit based on at least one user-designated criterion.

7. The method of claim 1 wherein the notification is generated based at least in part on at least one user-designated criterion.

8. The method of claim 1 wherein the user terminal is a mobile phone.

9. The method of claim 1 wherein said generation and transmission steps are carried out only if it is determined that the user account is signed up for receiving financial transaction notifications.

10. The method of claim 1 wherein:
the notification is generated and/or transmitted based at least in part on one or more user-designated criteria, said criteria including a notification type and a designation of the user terminal; and
the notification is one of an e-mail, a text message generated by a communication network short message service, and an electronically-generated voice message, as selected based on said notification type criterion, and the notification contains information relating to the financial transaction and identifying the user account.

11. The method of claim 1 wherein:
the notification contains an option for the user to place at least one of the financial transaction and the user account in a contested status; and
the method further comprises placing said at least one of the financial transaction and the user account in a contested status based on information received from the user terminal, said information indicating that the user has exercised said option.

12. A method of providing information to users about financial transactions, said method comprising:
for each financial transaction carried out in association with a user account, determining if the financial transaction meets one or more designated criteria; and, if so,
transmitting a notification to an external terminal associated with the user, said notification relating to the financial transaction.

13. The method of claim 12 wherein the designated criteria include at least one of a designated monetary size of the financial transaction, a frequency of the financial transaction, a location of the financial transaction, and a type of the financial transaction.

14. The method of claim 13 wherein:
the notification contains an option for placing at least one of the financial transaction and the user account in a contested status; and
the method further comprises placing said at least one of the financial transaction and the user account in a contested status based on information received from the user terminal, said information indicating that the user has exercised said option.

15. The method of claim 13 further comprising:
generating the notification based on a user-designated notification type and a user terminal designation, wherein the notification is one of an e-mail, a text message generated by a communication network short message service, and an electronically-generated voice message, as selected based on said notification type, and the notification contains information relating to the financial transaction, said information including at least one of an identifier associated with the user account, a monetary value of the transaction, and a time, date, and location of the transaction.

16. The method of claim 13 wherein the financial transaction is a credit card transaction or a debit card transaction.

17. The method of claim 13 wherein the external terminal is a mobile phone.

18. A method of providing information to users about financial transactions, said method comprising:
automatically generating a notification each and every time a credit card or debit card transaction is carried out in association with an account of a user, said notification including an identifier associated with the user account and at least one of a time, date, location, and monetary value of the financial transaction, and said notification being generated substantially immediately after the transaction is carried out; and
transmitting the notification to a terminal associated with the user, wherein the terminal is external to a financial network where the credit card or debit card transactions are carried out;
wherein the notification is one of an e-mail, a text message generated by a communication network short message service, and an electronically-generated voice message.

19. The method of claim 18 wherein the user terminal is a mobile phone.

20. The method of claim 18 wherein:
the notification contains an option for placing at least one of the transaction and the user account in a contested status; and
the method further comprises placing said at least one of the transaction and the user account in a contested status based on information received from the user terminal, said information indicating that the user has exercised said option.
